(19) United States
(12) Patent Application Publication
(10) Pub. No.: US 2019/0151751 A1
(43) Pub. Date: May 23, 2019

(54) MULTI-DIMENSIONAL MOVEMENT RECORDING AND ANALYSIS METHOD FOR MOVEMENT ENTRAINMENT EDUCATION AND GAMING

(71) Applicant: Nicholas Cooke Steadman, Omaha, NE (US)

(72) Inventor: Nicholas Cooke Steadman, Omaha, NE (US)

(21) Appl. No.: 15/815,710

(22) Filed: Nov. 17, 2017

(51) Int. Cl. A63F 13/211; A63F 13/46; A63F 13/212; A63F 13/216

(52) U.S. Cl. CPC A63F 13/211; A63F 13/46; A63F 13/212; G06F 3/017; A63F 2300/61; A63F 2300/1006; A63F 2300/5533; A63F 13/216

(57) ABSTRACT

A method of recording multiple dimensions of a user's movement using a gyroscope-equipped smart device and scoring it relative to a reference recording and/or set of inflection markers for use in dance games, flash mobs, and/or movement training applications.

### CROSS REFERENCE TO RELATED APPLICATIONS

This application claims priority to and benefit of U.S. Provisional Patent Application Ser. No. 62/423,773 filed on Nov. 18, 2016, the entire disclosure of which is incorporated by reference herein.

### FEDERALLY SPONSORED RESEARCH

None

### SEQUENCE LISTING

None

### BACKGROUND OF THE INVENTION

### Field of the Invention

The present invention generally relates to a system and a method for tracking the physical movement and position of a user and utilizing data obtained by tracking the physical movement and position in an electronic computer program. More particularly, the present invention relates to tracking the movement and orientation of one or more limbs of a user and incorporating the data obtained by tracking the movement and orientation of one or more limbs in an electronic computer program such as an electronic game, for example.

### Description of the Related Art

Current gaming systems exist that offer dance pads with pressure sensors designed to receive and process data relating to the position and timing of a user's steps. Other gaming systems employ manually operated devices such as gamepads, joysticks, controllers, mouses, and keypads. Generally, such conventional gaming systems are limited in the complexity of the data signals measured as well as the methods in which these data signals are processed.

For example, gaming consoles, such as Dance Dance Revolution (commonly referred to as “DDR”), utilize certain techniques to interactively receive signals from the movement of a user's foot during gameplay. Specifically, DDR is a music video gaming system produced by Konami Co., Ltd., that employs a dance pad consisting of foot panels or foot switches, which include a plurality of pressure sensors designed to detect a user's steps. The use of foot switches or panels with pressure sensors is discussed in U.S. Pat. No. 6,450,886, assigned to Konami Co., Ltd., and is incorporated by reference herein. Moreover, during DDR gameplay, arrows that are synchronized to the general rhythm or beat of a chosen song appear on a screen in front of the user. The user must step on the designated panel according to the arrows, where gaming success depends on the user's ability to time and position his or her steps accordingly.

Although DDR is capable of detecting the user's steps and processing the location and timing of these steps to interact with the rhythm or beat of a song, the use of dance pad limits the data signals being processed to the timing and position of steps made by the user. Moreover, the dance pads are large, cumbersome and relatively expensive.

Other gaming consoles, such as Nintendo's Wii® system, have taken advantage of motion-capturing components and improved speeds of wireless data transmission. Specifically, the Wii® system employs a controller that contains a combination of accelerometers and infrared detection technology, and that utilizes an array of light emitting diodes (“LEDs”) inside a so-called “Sensor Bar” to sense the position of the controller in 3D space. Accordingly, a user can play a Wii® game using physical arm movements or gestures, where data corresponding to the gestures is transmitted to a console via Bluetooth® technology.

The Wii® system, however, is limited in that the controller detects data corresponding to a physical gesture made by the user's hand and arm holding the controller, such as the gesture of a golf swing, for example, when the game pauses or prompts the user to provide input by making a gesture. The Wii® controller is not designed to detect the user's foot movement. Moreover, the processing of data transmitted by the Wii® controller generally is limited to a single gesture at a time rather than to a complex series of continuous movements involving multiple actions and steps. Further, the Wii® system processes each such single gesture such that a representation of that gesture is shown on a display screen after a significant time delay instead of in real time or close to real time during playing of the game.

More recently, computer games and multimedia applications have begun employing cameras and software gesture recognition engines to provide a human computer interface (“HCl”) or natural user interface (“NUI”). With HCI or NUI, user motions are detected, and some motions or poses represent gestures which are used to control game characters (e.g., a user's avatar) or other aspects of a multimedia application.

An aspect common to the foregoing background is the reliance on gaming consoles and specialized input devices, necessarily limiting the use of such methods in terms of physical location and in terms of the number of participants.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

Given the foregoing background, a need exists for a method that utilizes hardware that users already poses, such as the smartphones and/or smartwatches already in the users' pockets, on users' wrists, and/or affixed to users' upper arms, such as when they are exercising. The innovation not only utilizes the existing hardware allowing it to remain in its usual position in relation to the user's body, such as in the user's pant pocket, but also allows for measurement of the user's limb movements and positions independent of any physically stationary gaming console, sensor, or even wireless network. In this way, the innovation allows for a relatively unlimited number of users to participate. The users are also not limited as to their location, for they do not depend on any gaming console, sensor mechanism, or connection to a shared local network.

The present innovation is a method of recording multiple dimensions of a user's movement (three spacial dimensions over time) using a gyroscope-equipped smart device (smartphone, smart watch, etc.) and scoring it relative to a reference recording and/or set of inflection markers. The reference could be the recording of an exemplary model, or the averaged value of a group Inflection markers include but are not limited to the base rhythms of a song, as used for a dance education and gaming applications, or a marching rhythm when used for soldier training.

Scoring is a function of a.) the difference between the gyroscope recording values and the pre-set reference values, and/or b.) the difference between the timing of recording inflections relative to the timing of reference inflections and/or soundtrack landmark timing (inflection markers).

In other words, when using reference values to measure a user's score, the user mimics the precise movements and timing of the reference and is scored according to how accurately the gyroscope recorded values match with the reference values. When using the inflection marker method, scoring is based on how closely movement rhythms are synchronized. The reference value method is especially useful for teaching, learning, and judging precisely choreographed movements. The inflection marker method is more useful for measuring abstract rhythm entrainment of freestyle dancers, or other applications where only rhythm entrainment is desired.

This method allows measurement of choreographed movement including but not limited to choreographed dances, Japanese tea ceremony, factory assembly-line movements, and marching drills. Users can measure their progress, identify when and where they have the most room for improvement, and even learn better rhythm through real-time audio feedback.

This method may be used to quickly and accurately identify members whose movements are outliers, allowing for accelerated instruction by identifying the precise timing and nature of the outlier movements. Instructive feedback can be provided in real time and/or reviewed afterward.

A wide array of applications are possible, from dance games to military training to postural biofeedback.

### DESCRIPTION

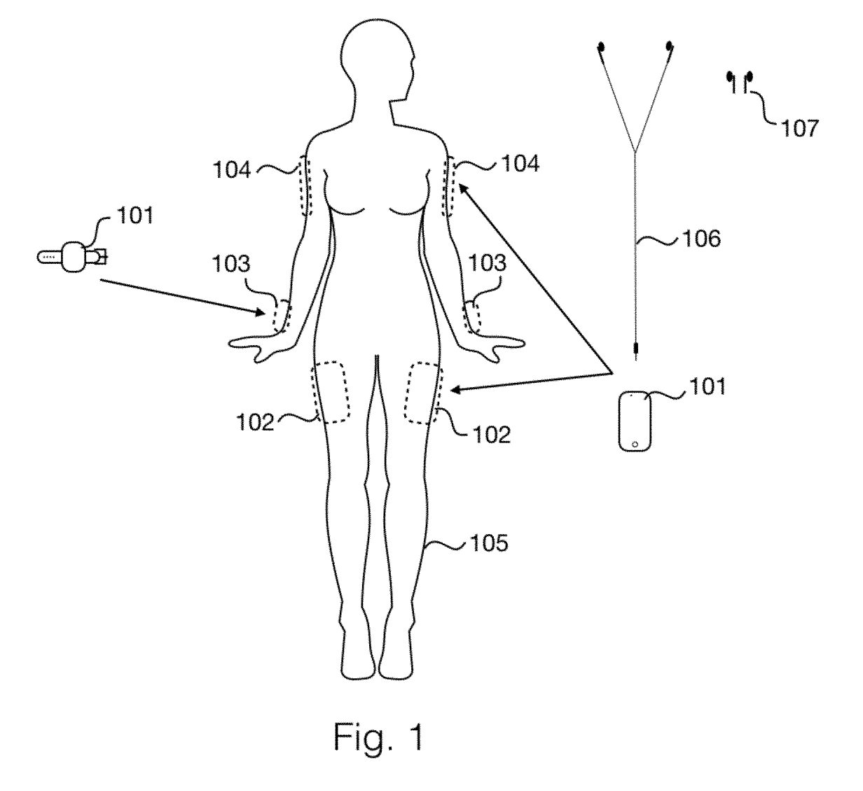

FIG. 1 illustrates three of the most common locations for the Smart Device(s) 101, in the Front Pocket 102, Wrist 103, and Upper Arm 104 of the User 105, and the headphones: Wired Headphones 106, Wireless Headphones 107

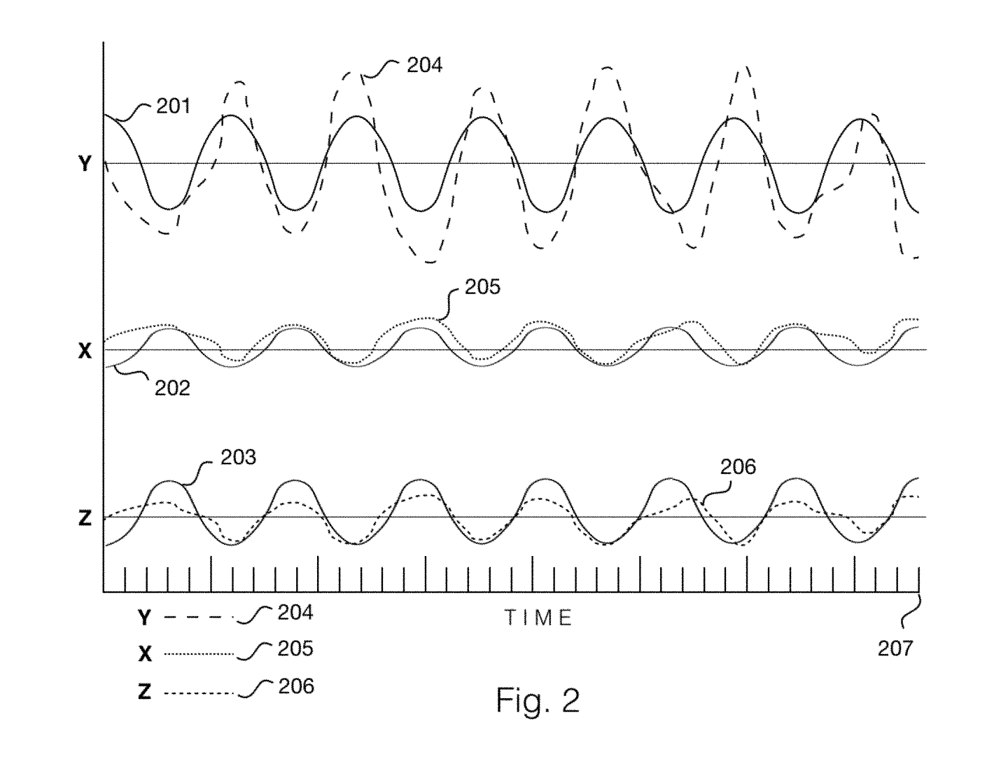

FIG. 2 shows Reference Values for Y 201, X 202, and Z 203. Recording Values for Y 204, X 205, and Z 206 are shown in comparison by matching elapsed Time 207.

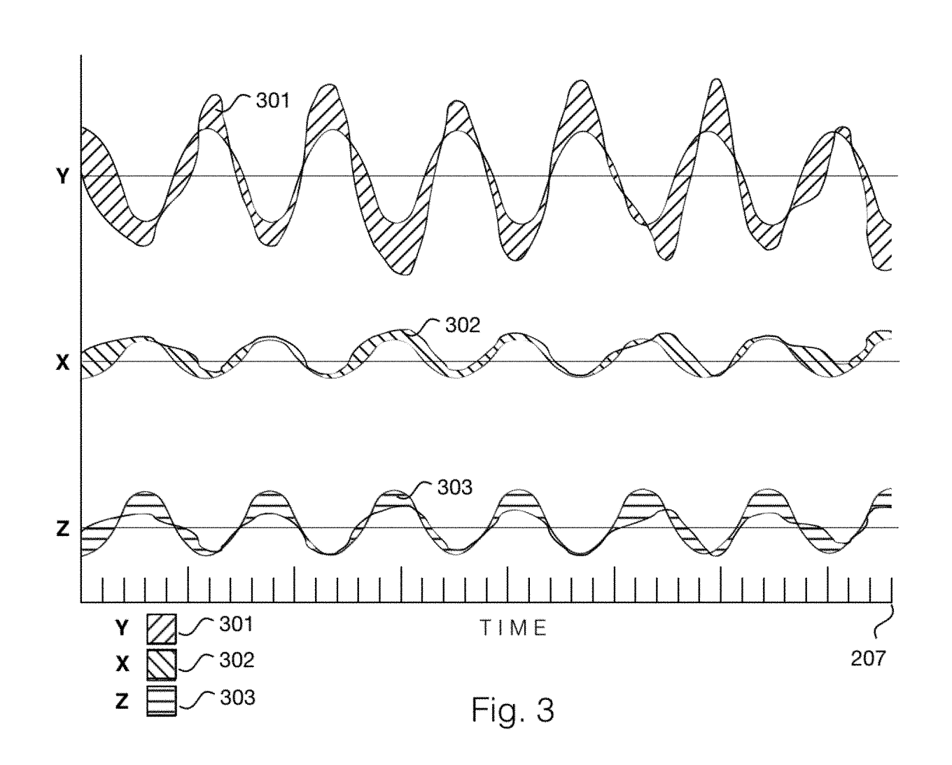

FIG. 3 The Orientation Differences. Y 301, X 302, Z 303 between the Reference Values (201, 202, 203) and Recording Values (204, 205, 206) is demonstrated by the corresponding shaded areas (301, 302, 303).

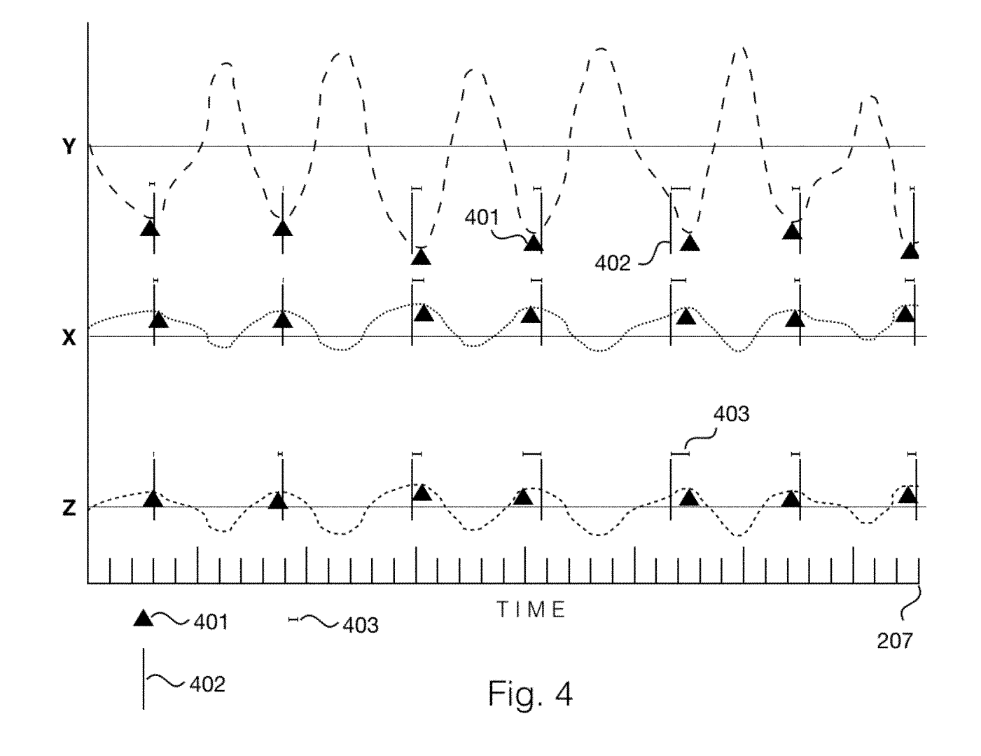

FIG. 4 shows Recording Inflection Points 401, Reference Inflection Points 402, and the Inflection Difference 403.

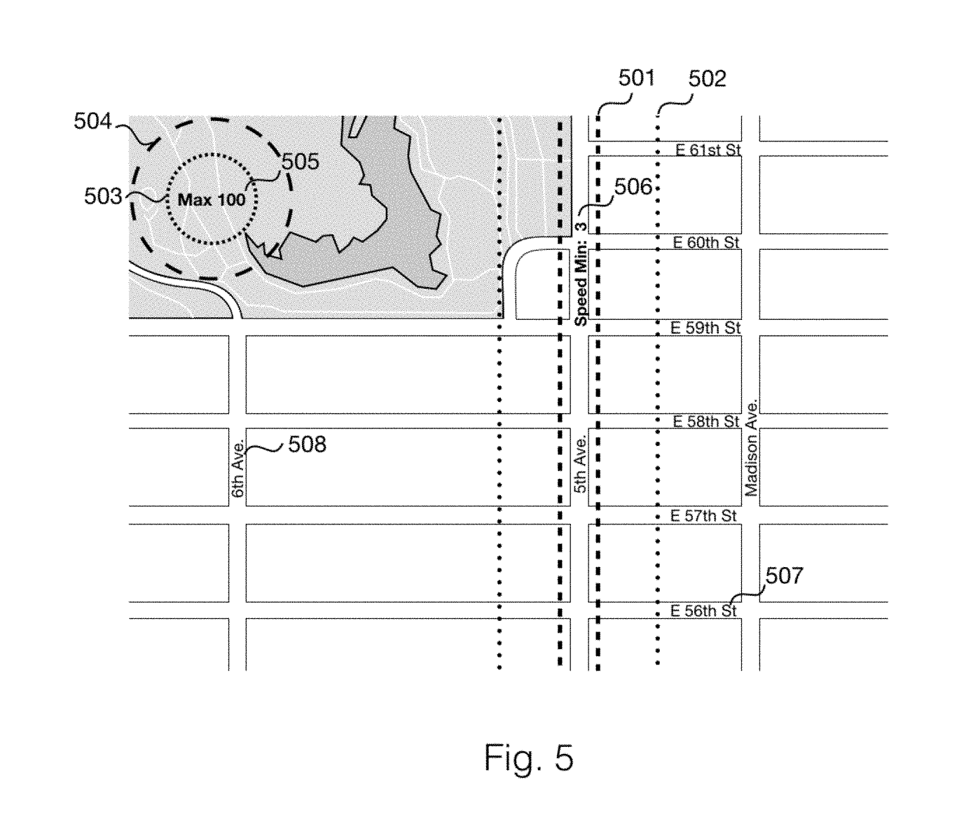

FIG. 5 shows geo-location based entrainment Audio Zones 501 with augmented reality audio “AR Audio Zones” 502 (distance-volume gradation). Also Point Zones 503 and AR Point Zones 504. Different areas may employ Size Limits 505 and/or Minimum Speed Limits 506. The Streets 507 and Avenues 508 are both clearly labeled.

### REFERENCE NUMERALS

101 Smart Device(s) 102 Front Pocket 103 Wrist
104 Upper Arm
105 User
106 Wired Headphones 107 Wireless Headphones 201 Reference Values Y
202 Reference Values X 203 Reference Values Z 204 Recording Values for Y 205 Recording Values for X 206 Recording Values for Z 207 Time
301 Orientation Differences Y 302 Orientation Differences X 303 Orientation Differences Z 401 Recording Inflection Points 402 Reference Inflection Points 403 Inflection Difference
501 Audio Zones
502 AR Audio Zones
503 Point Zones
504 AR Point Zones
505 Size Limits
506 Minimum Speed Limits 507 Streets
508 Avenues

### Operation

Reference Values (201, 202, 203) have either a.) been previously determined by the first Recording Values (204, 205, 206), or b.) were pre-set by an exemplary model using a predetermined method, or c.) the Reference Values (201, 202, 203) are determined by the plurality of users in movement, by averaging the Recording Values (204, 205, 206) of all the users.

Reference Inflection Points 402 have either been pre-set using a predetermined method or they can are determined during the movement (dance game, choreography, etc) by averaging a plurality of Recording Inflection Points 401 from a plurality of users. Recording Inflection Points 401 are determined as the extreme gyroscope values (the high points and/or low points). The three gyroscope spacial dimensions allow for a plurality of combinations, from both high and low points for all three dimensions, producing six simultaneous Recording Inflection Points 401. Alternatively, Recording Inflection Points 401 could be narrowly defined to just one polarity (eg low-points) of one dimension (eg Y 204). This wide range of possible Recording Inflection Points 401 provides flexibility, to meet the specific needs of different applications of the method.

Reference Values (201, 202, 203) and Reference Inflection Points 402 may be set for one or more locations, including but not limited to the Front Pocket 102, Wrist 103, and Upper Arm 104, for either one and/or both sides, as appropriate for the type of movement being entrained.

Gyroscope Recording Values (204, 205, 206) are recorded by the Smart Device 101 while the User 105 performs the desired movements. The User 105 may keep time by listening to a song via their Headphones (106 or 107) as they move with the Smart Device 101 affixed to a predetermined location, including but not limited to, their Front Pocket 102. Wrist 103, or Upper Arm 104.

The Smart Device 101 need not be limited to the standard locations (102, 103, 104). Indeed, as long as the location is the same when the Reference Values (201, 202, 203) are determined as when the Recording Values (204, 205, 206) are measured, it may be used in any location that best suits the application.

The Orientation Difference (301, 302, 303) and/or Inflection Difference 403 are calculated by the Smart Device 101 These differences (301, 302, 303, 303/403) could be observed as real time audio readings (which may be used as real-time feedback, to alert to being too fast or too slow on the beat), and/or viewed afterward.

### Minimum Speed Limits on Busy City Avenues:

Sidewalks on busy streets, like 5th Ave. in New York, may have Minimum Speed Limits 506 Groovin' will require respecting the Speed Limit 506, to avoid disrupting pedestrian traffic. (Indeed, this can even encourage users to “groove” faster than the average walking speed of the area, to help prevent congestion and avoid negative public sentiment.)

### “Augmented Reality Audio”:

For activities including but not limited to public dancing, or “groovin” (walking in rhythm with music), the use of geo-location based audio entrainment zones, or AR Audio Zones 502 provide “augmented reality audio” via a distance-volume gradation. This allows for Users 105 to hear the music at a lower volume as they are getting closer to an Audio Zone 501. The music gets louder as the User 105 passes through the AR Audio Zone 502, until reaching full volume when they enter the Audio Zone 501. For example, if a User 105 is walking West on E 56th St. (507) and approaching the 5th Avenue Audio Zone 501, they will begin to hear the music playing in the 5th Ave Audio Zone 501 as early as half a block away.

If the orientation of the User 105 is know with a predetermined degree of accuracy (for example if their Smart Device 101 is a pair of augmented reality glasses) the AR Audio Zones 502 may further enhance the “augmented reality” effect by altering the volume between each ear (or even introducing a micro-delay) to enhance the perception of the music coming from the direction of the Audio Zone 501.

### Jukeboxes:

Another of a multiplicity of uses for Point Zones 503 is to be used like an augmented reality “jukebox.” Point Zones 503 could also be made mobile, like an augmented reality “boom box.”

### Note on Self-Organizing Regulation:

By adjusting the size, location, and number of Point Zones 503, the location and concentration of silent raves can self-organize to accord with predetermined parameters. For example, if a park has a predetermined Size Limit 505 for silent rave dance games, the Point Zone 503 could divide into two-dividing the dancers (aka Users 105) evenly into the two groups, and guide them to different areas of the park, or even relocate one to an entirely new nearby location. This may be automatically employed whenever a Point Zone 503 gets over-enrolled, instead of simply denying new Users 105 from joining.

Self-organization can also help keep dancing, and groovin', within socially acceptable and legal limits. For example, a neighbor or police request could be used to trigger an automatic limiting, redirection, division, dispersion, and/or relocation of a public dance game which has been deemed too disruptive, using a predetermined method.

Speed limits could also be self-organized based on a predetermined method and a plurality of inputs including, but not limited to: a.) the measurements of average pedestrian speeds in the Audio Zone 501 in question, b.) User 105 opinion feedback, and/or c.) the numbers and/or speeds which have been known to historically trigger complaints in the Audio Zone 501 in question.

Other self-organizing methods may be utilized to help users take full advantage of the benefits of this method, while also balancing the complex and often conflicting desires of pedestrians, workers, and residents in crowded urban environments, using predetermined methods.

1. A method of recording multiple dimensions of a user's movement (three spacial dimensions over time) using a gyroscope-equipped smart device (smartphone, smart watch, etc.) and scoring it relative to a reference recording and/or set of inflection markers, comprising:
recording time-stamped limb orientation data from one or more gyroscope-equipped smart device(s) affixed to predetermined locations upon a user's limb(s); scoring said orientation data by relative comparison with a reference recording and/or set of inflection markers, determining said reference recordings as the recording of an exemplary model, or the averaged value of a group of users; determining said inflection markers as including but not limited to the base rhythms of a song, as used for dance education and gaming application, or a marching rhythm when used for soldier training, said scoring being a function of a.) the difference between the gyroscope recording values and the pre-set reference values, and/or b.) the difference between the timing of the recording inflections relative to the timing of reference inflections and/or soundtrack landmark timing, aka “inflection markers.”

2. The method of claim 1, wherein multiple users listen to synchronized music recording played on their own headphones and dance freestyle to said music with the recording smart device(s) in a predetermined location on their person as a silent disco dance game.

3. The method of claim 2, wherein the users are scored by their accuracy as measured by their movement inflection relative to predetermined reference inflections.

4. The method of claim 1, wherein multiple users listen to synchronized music recording played on their own headphones and dance to predetermined choreography to said music with the recording smart device(s) in a predetermined location on their person as a flash mob dance game.

5. The method of claim 4, wherein the users are scored by their accuracy as measured by their overall movement fidelity to one dimension of a predetermined reference recording.

6. The method of claim 4, wherein the users are scored by their accuracy as measured by their overall movement fidelity to all dimensions of a predetermined reference recording.

7. The method of claim 2, wherein the users are scored by their accuracy as measured by their movement inflection relative to the average inflection value of said group.

8. The method of claim 1, wherein multiple users listen to synchronized music recording played aloud on a stereo system and dance freestyle to said music with the recording smart device(s) in a predetermined location on their person as a silent disco dance game.

9. The method of claim 1, wherein multiple users listen to synchronized music recording played aloud on a stereo system and dance to predetermined choreography to said music with the recording smart device(s) in a predetermined location(s) on their person as a flash mob dance game.

10. The method of claim 9, wherein the users are scored by their accuracy as measured by their overall movement fidelity to one dimension of the average value of all users' recordings.

11. The method of claim 9, wherein the users are scored by their accuracy as measured by their overall movement fidelity to all dimensions of the average value of all users' recordings.
